(19) United States
(12) Patent Application Publication
(10) Pub. No.: US 2007/0056763 A1
(43) Pub. Date: Mar. 15, 2007

(54) Cable containment system

(76) Inventor: John Anthony Kelly, Lancashire (GB)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/558,797

(22) PCT Filed: Apr. 29, 2004
(86) PCT No.: PCT/GB04/01843

§ 371 Date: Sep. 8, 2006

(30) Foreign Application Priority Data
May 1, 2003 (GB) 0309993.4

(51) Int. Cl. H01B 7/00

(52) U.S. Cl. 174/135

(57) ABSTRACT

A cable containment box that is constructed to minimise waste. It comprises one or more pieces of sheet material (5a, 5b, 5c; 105) adapted to be folded or otherwise configured to form a container having a first shape (1) for accommodating cable for storage and transportation purposes, means (3) being provided for securing said sheet material in said first shape, and wherein at least some of the one or more pieces of sheet material (5a, 5b, 5c; 105) are adapted to be configured to form a second shape for use in protecting cables after installation, and further comprising means for securing said at least one piece in said second shape. The means facilitating folding into the first shape comprises fold lines (7, 9; 31-39) in the sheet material. The means facilitating folding into the second shape comprises further fold lines (21, 23, 25; 81, 83, 85). The further fold lines are perpendicular to the first mentioned fold lines. The second shape is preferably triangular when viewed in cross-section and the sheet material is preferably a corrugated material in which the direction of the corrugations is perpendicular to the direction of the second fold lines.

The present invention relates to a cable containment system.

In the wiring of buildings, be it for mains electrical wiring, telephone or data cabling, large quantities of cable have to be transported on to the site. The cable is usually accommodated in cable boxes made of cardboard. After removal of the cable from the boxes, the boxes have to be disposed of. The quantity of waste so generated can be considerable for a large office block or other commercial premises. Installation contracts frequently require installers to be responsible for disposal of waste and/or to minimise waste as much as possible.

In my co-pending UK patent application I describe supplying data cables in pre-made looms, including end terminals. These are supplied in cardboard transportation containers which have to be disposed of after use. Furthermore, in the case of data cabling, installation specifications increasingly require cables to be protected from potential damage after installation. This usually dictates placing the cables in protective cable trays or conduit.

It is an aim of one aspect of the invention to construct the aforesaid cable boxes and/or transportation containers, at least in the case of those for data cables, in an advantageous way that minimises waste.

Accordingly, one aspect of the present invention provides a cable containment box comprising one or more pieces of sheet material adapted to be folded or otherwise configured to form a container having a first shape for accommodating cable for storage and transportation purposes, means being provided for securing said sheet material in said first shape, and characterised in that at least some of the one or more pieces of sheet material are adapted to be configured to form a second shape for use in protecting cables after installation, and further comprising means for securing said at least one piece in said second shape.

More particularly the second shape functions as a protective cable tray or conduit. The first shape will usually be cuboid or rectangular. Preferably the second shape is a hollow elongate conduit. A conduit having a triangular cross-section is preferred for maximum strength considerations.

The sheet material may be plastics or cardboard and preferably is of corrugated construction for strength considerations. By corrugated construction we mean at least one layer of material having elongated corrugations (eg: ribs and troughs) sandwiched between two planar layers, or in the case of plastics material, at least two parallel sheets connected by spaced elongate webs. A material such as Correx has been found particularly suitable. Such a material has the advantage of having low smoke properties, zero halogen, as well as flame retardant properties and water penetration resistant properties.

It is preferred that the one or more pieces of sheet material are elongate elements in their developed form. Each piece will conveniently have at least one lateral line of weakness defining a or a respective crease or fold line along which the element is folded in forming the first shape. More preferably each element has at least two lateral fold lines along which the element is folded in forming the first shape. Preferably the corrugations of the material from which each element is formed extend in the lateral direction.

The means to hold the pieces of sheet material in the first shape conveniently comprise tie bands applied around the periphery of the first shape. Preferably at least two tie bands are used and disposed in intersecting plains. Alternatively adhesive tape may be used extending around the first shape in the same manner, and/or applied over the joints for sealing purposes.

More particularly, the one or more elongate elements have at least one, and preferably a plurality, of longitudinally extending lines of weakness defining a or a respective crease or fold line along which the element is folded in forming the second shape. In the case of the preferred second shape having a triangular cross-section, each element preferably has three longitudinal lines of weakness defining three sides of the second shape and a closure flap which in use overlaps one of the other sides. The means to hold the elements in the second shape may also comprise tie wraps or tie bands applied around the periphery of the second shape at discrete intervals. In one embodiment the elements are provided with pieces or lengths of hook and loop type fastening material, such as that known by the trade mark Velcro, the hook material being positioned to one side of the element and the loop material to the other side and disposed to be aligned with one another when the element is formed into its second shape thereby holding the element in its second shape. In one embodiment the hook and loop fastening material extends along the complete longitudinal extent of the elements. In another embodiment double-sided adhesive tape is used as an alternative to Velcro. In that case only one side of the element needs to be provided with the tape, and its release sheet removed when required to be brought into use. Preferably the double-sided tape is on the inside when the sheet material is in its first shape.

In use the elongate element is laid out along the path of the intended cable run, the cables laid on them and then the element folded up into the second shape and secured in that shape.

Preferably connecting elements are provided to maintain alignment between adjacent elongate elements where they abut one another in end-to-end relation. Conveniently the connecting elements comprise hollow elements that are formed in a corresponding manner from sheet material and dimensioned as a close fit within the hollow interior of the second elements or dimensioned to fit around the exterior thereof. In the case where the second shape has a triangular cross-section, the connecting element will preferably have a triangular cross-section. Where fitted internally the overlapping flap can be omitted and the securing means of the second shape relied upon. Where fitted externally the connecting element may have an overlapping flap and corresponding connecting means to that of the element forming the second shape. Alternatively other securing means may be used such as circumferentional securing bands which may then avoid the need for the overlapping flap on the connecting element.

Depending on the length of the elongate element forming the second shape, and hence the length of the second shape, the means securing the interconnecting elements in position may be sufficient to hold the elongate elements in their second shape without the need for them to be provided with separate securing means.

In one embodiment, each first shape is formed from three pieces and each piece has two lateral lines of weakness at which 90° folds are formed. Three U-shaped elements so formed are easily assembled into a box shape as described in the following example.

In another embodiment a single piece of elongate sheet material has a plurality of lateral fold lines and one diagonal fold line to facilitate folding up into a box shape. The single elongate piece may be cut into shorter pieces that are then formed into the second shape. Longitudinal lines of weakness are provided to facilitate this in the same manner as described above.

Another aspect of the invention comprises a cable containment tray formed of sheet material that has a hollow triangular configuration as viewed in cross-section.

More particularly, the three sides thereof are defined by crease lines in the sheet material that allow the triangular shape to be formed by folding up the sheet material. More particularly still there are three crease lines, with the third defining a closure flap that overlaps with one of the other sides on assembly.

Securing means is applied to the sheet material to facilitate holding it in the triangular shape. The securing means may comprise hook and loop fixing means, or adhesive tape, for example, double-sided adhesive tape. Conveniently the tape runs along the length of one side, preferably adjacent a crease line.

The preferred sheet material comprises a lightweight low smoke plastics material, preferably of corrugated construction and preferably a material sold under the trade name Correx (probably registered). The corrugations extend in a direction perpendicular to the direction of the crease lines.

The present invention will now be described further hereinafter, by way of example only, with reference to the accompanying drawings:—

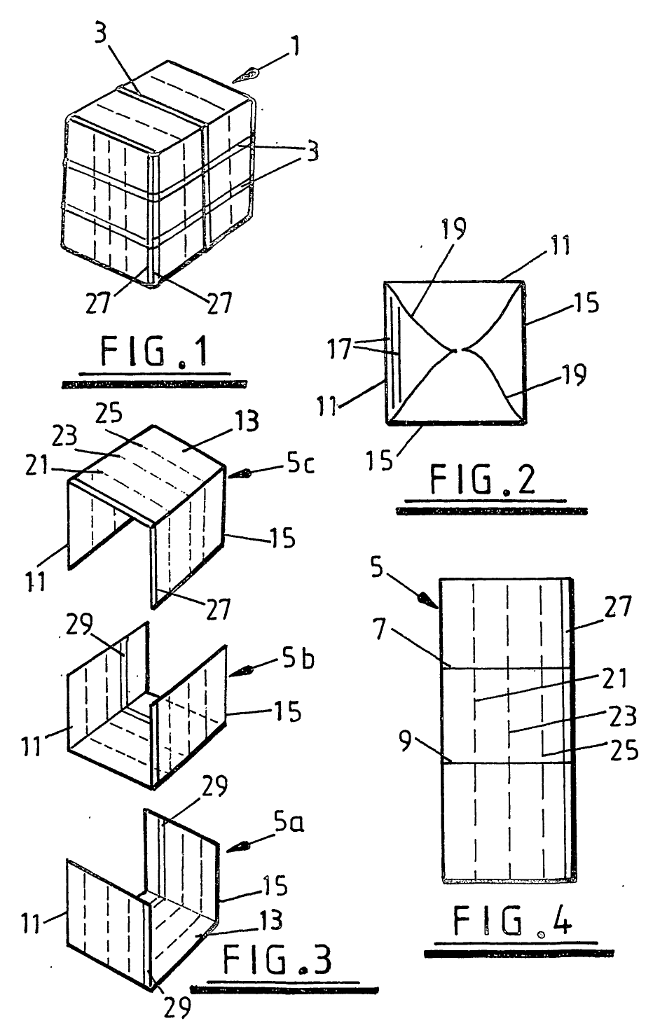

FIG. 1 is a perspective view of a cable containment box in its first shape,

FIG. 2 is a plan view of the box of FIG. 1 with the top removed to see internal detail,

FIG. 3 is an exploded perspective view showing the three elements that form the first shape of the box,

FIG. 4 is a developed view of one of the three elements shown in FIG. 3,

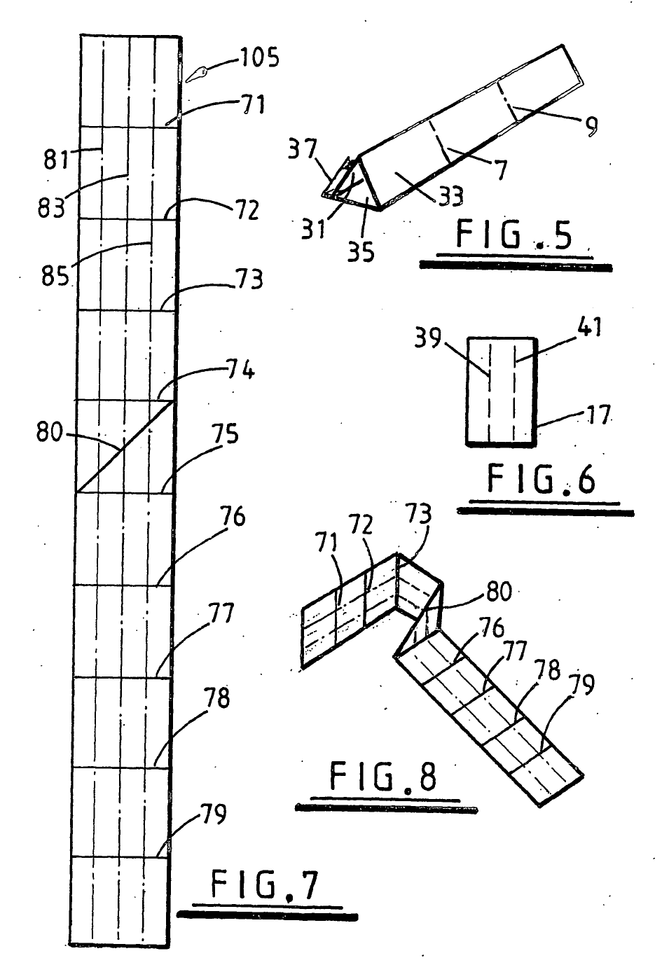

FIG. 5 is a perspective view of the element of FIG. 4 formed into its second shape,

FIG. 6 is a developed view of an interconnecting element,

FIG. 7 is a developed view of an elongate element for forming a rectangular box from one piece according to another embodiment, and

FIG. 8 is a perspective view showing the other embodiment of FIG. 7 partially assembled into its first shape.

The present invention will now be described, by way of example only, with reference to the first embodiment of FIGS. 1 to 6. The cable containment box is shown in its assembled form in FIG. 1 and comprises a substantially rectangular six sided box referred to generally as 1 and held in that shape by three plastic tie bands 3. Adhesive tape may be used as an alternative. The box is formed from three elements 5a, 5b and 5c of sheet material whose developed form is shown in FIG. 4. Each element is formed of elongate sheet material which according to the preferred embodiment comprises corrugated plastics material known under the trade name Correx. Each element 5a,b,c has two lateral lines of weakness 7,9 and in three panel sections 11,13 and 15. Sections 11 and 15 are folded along the respective lines of weakness 7,9 to be disposed at 90° to the section 13. Section 13 is square and sections 11 and 15 have the same shape as one another and most usually will also be square, but could be rectangular. In assembling the containment box into its first shape two of the elements referenced 5a and 5b in FIG. 3 are nested together with sections 13 aligned with one another but disposed at 90° with respect to one another so that the flap portions 11,15 of the first element 5a are disposed at 90° to the flap portions 11,15 of the second element 5b. The cable may then be introduced into the box.

When the box is used for transporting made-up cable looms it is preferred to install them in a figure of eight and it is preferred to include two V-shaped inserts 19 to aid positioning of the cable and subsequent playing out of the cable from the box. Also shown in the box are two additional sheet elements 17 which are described further hereinafter with reference to FIG. 6.

Once the cable has been introduced into the box the third section labelled 5c in FIG. 3 is placed in position. Once in place the containment box is secured in its first shape by the peripheral bands 3 as shown in FIG. 1.

Referring again to FIG. 4, it will be seen that each elongate element also has three longitudinal lines of weakness 21,23 and 25 and in the illustrated embodiment has along one edge a length of hook and loop fastening material 27. A complementary connecting length of hook and loop fastening material 27 is secured to the other side of the element as represented by dotted line 29. The corrugations of the material from which each element is made extend laterally. Alternatively the hook and loop fastening material may be replaced by double-sided adhesive positioned at 29.

Once the cable has been delivered on site and deployed from its box, each of the elements 5 is formed into its second shape by folding it along the longitudinal lines of weakness 21,23 and 25 to form a triangular shape as shown in FIG. 5 thus forming longitudinal panels 31,33,35 and 37. Note that panel 37 forms a flap which overlies panel 31. The second shape is able to withstand considerable impact loads.

Finally FIG. 6 illustrates a piece of sheet material 17 which is preferably made for corrugated material and which has two longitudinal lines of weakness 39,41. These permit it to be formed into a triangular shape which is dimensioned to fit within the hollow section of the second shape shown in FIG. 5. By this means adjacent cable containment boxes when formed into the second shape and abutted end to end can be held in alignment.

Thus it will be apparent from the above that material which might otherwise be wasted which is used for transporting cables to an installation location can be re-used by forming into the second shape which is used as a cable containment tray.

FIGS. 7 and 8 show another way of forming a cable containment box 101 from sheet material 105 in a first shape for purposes of storing and transporting cable and which can be re-formed into a second shape which serves the purpose of a cable containment conduit in the same manner as described with reference to FIGS. 1 to 6. The single element comprises nine lateral lines of weakness 71-79 and a diagonal line of weakness 80. The lines of weakness define panels which form sides of the box when folded up. Some of the sides will be doubled up to aid integrity. Also shown in FIG. 7 are the longitudinal lines of weakness 81,83 and 85 which allow the element to be formed into the second elongate conduit shape, as in FIG. 5. Where necessary the long length of sheet material 105 can be cut into shorter lengths, say along the lines of the lateral creases, for ease of handling. The sheet material 105 when folded is secured in its first shape by peripheral bands 3 as shown in FIG. 1. The internal configuration can be the same as that shown in FIG. 2. By this means a single piece of material can be formed into a box of the first shape and then reformed into one or more second shapes for use as a cable containment conduit.

The triangular cable containment tray according to the other aspect of the invention is constructed substantially as described with reference to the accompanying drawings of FIGS. 4 and 5, except that it is not required to have the transverse crease lines 7,9 as it is not required to be capable of being transformed from a first 3 dimensional shape to a second 3 dimensional shape. It is merely required to be formed into the triangular shape.

1. A cable containment box comprising one or more pieces of sheet material (5a, 5b, 5c; 105) adapted to be folded or otherwise configured to forma container having a first shape (1) for accommodating cable for storage and transportation purposes, means (3) being provided for securing said sheet material in said first shape, and characterised in that at least some of the one or more pieces of sheet material (5a, 5b, 5c; 105) are adapted to-be configured to form a second shape for use in protecting cables after installation, and further comprising means for securing said at least one piece in said second shape.

2. A cable containment box as claimed in claim 1 in which the second shape functions as a protective cable tray or conduit.

3. A cable containment box as claimed in claim 1 in which the first shape is cuboid or rectangular.

4. A cable containment box as claimed in claim 1 in which the second shape is a hollow elongate conduit.

5. A cable containment box as claimed in claim 4 in which the conduit has a triangular cross-section.

6. A cable containment box as claimed in claim 1 in which the sheet material is plastics or cardboard.

7. A cable containment box as claimed in claim 6 in which the plastics or cardboard is of corrugated construction.

8. A cable containment box as claimed in claim 7 in which the corrugated construction comprises at least one layer of material having elongated corrugations sandwiched between two planar layers.

9. A cable containment box as claimed in claim 7 in which, in the case of plastics material, the corrugated construction comprises at least two parallel sheets connected by spaced elongate webs.

10. A cable containment box as claimed in claim 1 in which the one or more pieces of sheet material (5a, 5b, 5c) are elongate elements in their developed form.

11. A cable containment box as claimed in claimed in claim 1 in which any one of the preceding claims in which the one or more pieces of sheet material have at least one lateral line of weakness defining a or a respective crease or fold line along which the element is folded in forming the first shape.

12. A cable containment box as claimed in claim 11 in which each element has at least two lateral fold lines (7, 9) along which the element is folded in forming the first shape.

13. A cable containment box as claimed in claim 8 in which the corrugations of the material from which each element is formed extend in the lateral direction.

14. A cable containment box as claimed in claim 1 in which the means to hold the pieces of sheet material in the first shape comprise tie bands applied around the periphery of the first shape.

15. A cable containment box as claimed in claim 14 in which at least two tie bands are used and disposed in intersecting planes.

16. A cable containment box as claimed in claim 1 in which the means to hold the pieces of sheet material in the first shape comprises adhesive tape extending around the first shape, and/or applied over the joints for sealing purposes.

17. A cable containment box as claimed in claim 1 in which any one of the preceding claims in which the one or more pieces of sheet material have at least one, longitudinally extending lines of weakness defining a or a respective crease or fold line (21,23, 25; 81,83, 85) along which the material is folded in forming the second shape.

18. A cable containment box as claimed in claim 17 in which there are a plurality of said longitudinally extending crease or fold lines.

19. A cable containment box as claimed in claim 1 in which any one of the preceding claims in which the second shape has a triangular cross-section.

20. A cable containment box as claimed in claim 19 in which the sheet material has three longitudinal lines of weakness defining three sides of the second shape and a closure flap which in use overlaps one of the other sides.

21. A cable containment box as claimed in claim 1 in which the means to hold the sheet material in the second shape comprises tie wraps or tie bands applied around the periphery of the second shape at discrete intervals.

22. A cable containment box as claimed in claim 1 in which the sheet material is provided with pieces or lengths of hook and loop type fastening material, the hook material being positioned to one side of the sheet material and the loop material to the other side and disposed to be aligned with one another when the sheet material is formed into its second shape thereby holding the sheet material in its second shape.

23. A cable containment box as claimed in claim 22 in which the hook and loop fastening material extends along the complete longitudinal extent of the sheet material.

24. A cable containment box as claimed in claim 1 in which double-sided adhesive tape is used as the means to hold the container in its second shape.

25. A cable containment box as claimed in claim 1 in which, in use, the sheet material is laid out along the path of the intended cable run, the cables laid on them and then the element folded up into the second shape and secured in that shape.

26. A cable containment box as claimed in claim 1 and further comprising connecting elements to maintain alignment between adjacent pieces, when formed into their second shape where they abut one another in end-to-end relation.

27. A cable containment box as claimed in claim 26 in which the connecting elements comprise hollow elements that are formed by folding up from sheet material and dimensioned as a close fit within the hollow interior of the pieces in the second shape or dimensioned to fit around the exterior thereof.

28. A cable containment box as claimed in claim 26 in which, in the case where the second shape has a triangular cross-section, each connecting element has a triangular cross-section.

29. A cable containment box as claimed in claim 27 when the connecting means is fitted externally and wherein the connecting means is provided with an overlapping flap.

30. A cable containment box as claimed in claim 27 when the connecting element is fitted externally and wherein the connecting element has connecting means to secure the box in its second shape.

31. A cable containment box as claimed in claim 1 in which each first shape is formed from three pieces and each piece has two lateral lines of weakness at which 90° folds are formed to form three U-shaped elements which are assembled into a box shape.

32. A cable containment box as claimed in claim 1 in which the first shape is formed from a single piece of elongate sheet material and has a plurality of lateral fold lines and one diagonal fold line to facilitate folding up into a box shape.

33. A cable containment box as claimed in claim 32 in which the single elongate piece is cut into shorter pieces that are then each formed into the second shape.

34. A cable containment tray formed of sheet material and having a hollow triangular configuration as viewed in cross-section.

35. A cable containment tray as claimed in claim 34 in which the three sides thereof are defined by crease lines in the sheet material that allow the triangular shape to be formed by folding up the sheet material.

36. A cable containment tray as claimed in claim 34 in which there are three crease lines, with the third defining a closure flap that overlaps with one of the other sides on assembly.

37. A cable containment tray as claimed in claim 34 in which securing means is applied to the sheet material to facilitate holding it in the triangular shape.

38. A cable containment tray as claimed in claim 37 in which the securing means comprises hook and loop fixing means, or adhesive tape.

39. A cable containment tray as claimed in claim 38 in which the securing means comprises an elongate strip which runs along the length of one side.

40. A cable containment tray as claimed in claim 34 in which the sheet material comprises a plastics material of corrugated construction.

41. A cable containment tray as claimed in claim 40 in which the corrugations extend in a direction perpendicular to the direction of the crease lines.

42. (canceled)

43. (canceled)
